(19) United States
(12) Patent Application Publication
(10) Pub. No.: US 2021/0195150 A1
(43) Pub. Date: Jun. 24, 2021

(54) OPERATION METHOD AND DISPLAY APPARATUS

(71) Applicant: SEIKO EPSON CORPORATION, Tokyo (JP)

(72) Inventor: Makoto KOBAYASHI, Matsumoto-shi (JP)

(21) Appl. No.: 17/126,132

(22) Filed: Dec. 18, 2020

(30) Foreign Application Priority Data
Dec. 20, 2019 (JP) 2019-230091

(51) Int. Cl. H04N 9/31; G06F 3/16; H04N 5/60

(52) U.S. Cl. CPC H04N 9/3179; H04R 1/028; H04N 5/60; G06F 3/165

(57) ABSTRACT

An operation method for a display apparatus includes displaying an image on a display surface, outputting a sound signal representing sound, and, when receiving an instruction to set sound quality of sound represented by the sound signal to first sound quality, setting the sound quality to the first sound quality and setting image quality of the image to first image quality associated with the first sound quality.

The present application is based on, and claims priority from JP Application Serial Number 2019-230091, filed Dec. 20, 2019, the disclosure of which is hereby incorporated by reference herein in its entirety.

### BACKGROUND

### 1. Technical Field

The present disclosure relates to an operation method and a display apparatus.

### 2. Related Art

JP-A-2009-49808 discloses an image processing apparatus that displays images and outputs sound signals. The image processing apparatus can change image quality of the images and sound quality of sound.

In a display apparatus that displays images and outputs sound signals like the image processing apparatus disclosed in JP-A-2009-49808, when one of sound quality and image quality is changed, it is desirable to change the other of the sound quality and the image quality according to the change of the one of the sound quality and the image quality. However, it is complex for a user to make both a change in sound quality and a change in image quality at each time.

### SUMMARY

An aspect of an operation method according to the present disclosure is an operation method for a display apparatus including displaying an image on a display surface, outputting a sound signal representing sound, and, when receiving an instruction to set sound quality of sound represented by the sound signal to first sound quality, setting the sound quality to the first sound quality and setting image quality of the image to first image quality associated with the first sound quality.

An aspect of a display apparatus according to the present disclosure includes a display unit that displays an image on a display surface, a sound signal output unit that outputs a sound signal representing sound, and a processing unit, when receiving an instruction to set sound quality of sound represented by the sound signal to first sound quality, that sets the sound quality to the first sound quality and sets image quality of the image to first image quality associated with the first sound quality.

### BRIEF DESCRIPTION OF THE DRAWINGS

FIG. 1 shows a display system 1000.

FIG. 2 shows an example of a projector 2.

FIG. 3 shows an example of a projection unit 28.

FIG. 4 shows an example of a sound mode.

FIG. 5 shows an example of a color mode.

FIG. 6 shows an example of a setting mode.

FIG. 7 shows an example of a first table 251.

FIG. 8 shows an example of a second table 252.

FIG. 9 is a flowchart for explanation of an example of an operation in the setting mode.

FIG. 10 is a flowchart for explanation of an example of an operation in a link mode.

FIG. 11 is a flowchart for explanation of an example of an operation in a movie content mode.

FIG. 12 is a flowchart for explanation of an example of an operation in a game content mode.

FIG. 13 is a flowchart for explanation of an example of an operation in a custom mode.

### DESCRIPTION OF EXEMPLARY EMBODIMENTS

### A: First Embodiment

### A1: Outline of Display System 1000

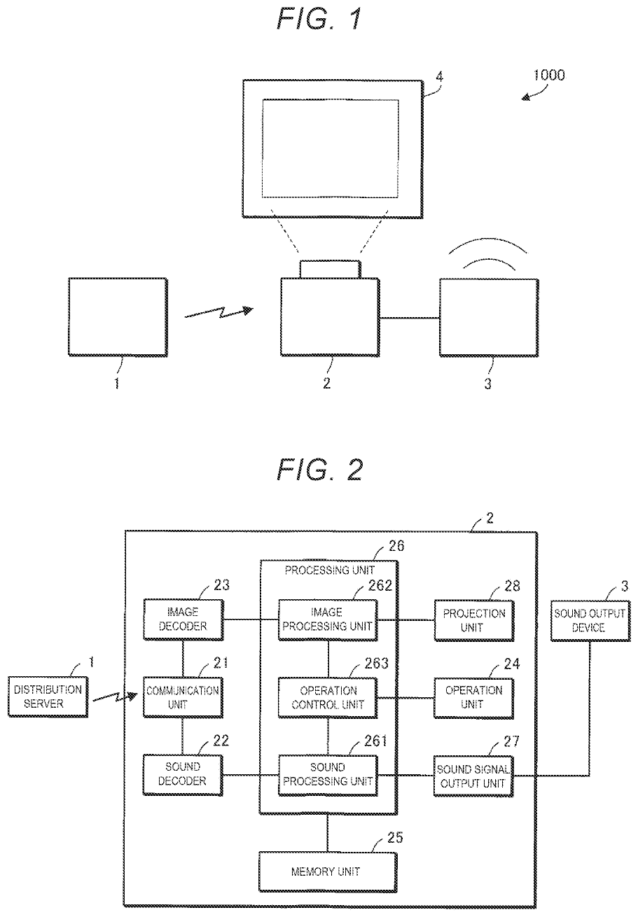

FIG. 1 shows a display system 1000. The display system 1000 includes a distribution server 1, a projector 2, and a sound output device 3.

The distribution server 1 transmits delivery data to the projector 2. The delivery data includes image data representing images and sound data representing sound. The image data and the sound data are respectively encoded data. The delivery data is e.g. data representing movies. The delivery data is not limited to the data representing movies, but may be e.g. data representing music programs, data representing sports programs, or data representing online games.

The distribution server 1 is an example of an image data delivery apparatus. The image data delivery apparatus, i.e., a delivery apparatus that delivers image data and sound data is not limited to the distribution server 1. The delivery apparatus that delivers image data and sound data may be e.g. a PC (Personal Computer), a tablet terminal, a smartphone, a video reproduction apparatus, a DVD (Digital Versatile Disc) player, a Blu-ray disc player, a hard disc recorder, a television tuner, or a video game machine.

The projector 2 is an example of a display apparatus. The display apparatus is not limited to the projector 2, but may be a display e.g. an FPD (Flat Panel Display). The FPD is e.g. a liquid crystal display, a plasma display, or an organic EL (Electro Luminescence) display.

The projector 2 receives delivery data from the distribution server 1. The projector 2 extracts image data and sound data from the delivery data. The projector 2 decodes the image data to generate image signals representing images. The projector 2 projects the images represented by the image signals on a projection surface 4 and displays the images on the projection surface 4. The projector 2 decodes the sound data to generate sound signals representing sound. The projector 2 outputs the sound signals to the sound output device 3.

The sound output device 3 is e.g. a speaker. When the sound output device 3 is a speeder, the sound output device 3 may be provided in the projector 2. The sound output device 3 is not limited to the speaker, but may be e.g. a headphone or earphone. The sound output device 3 receives the sound signals and outputs sound represented by the sound signals.

The projection surface 4 is e.g. a screen. The projection surface 4 is not limited to the screen, but may be e.g. a part of a wall, a door, or a whiteboard. The projection surface 4 is an example of a display surface.

The projector 2 sets sound quality represented by the sound signals output to the sound output device 3 according to an instruction by a user. Further, the projector 2 sets image quality of the images displayed on the projection surface 4 according to an instruction by the user.

### A2: Example of Projector 2

FIG. 2 shows an example of the projector 2. The projector 2 includes a communication unit 21, a sound decoder 22, an image decoder 23, an operation unit 24, a memory unit 25, a processing unit 26, a sound signal output unit 21, and a projection unit 28.

The communication unit 21 is e.g. a communication circuit. The communication unit 21 communicates with the distribution server 1 via wired or wireless connection. The communication unit 21 may communicate with the distribution server 1 via wired or wireless connection. The communication unit 23 receives delivery data from the distribution server 1. The communication unit 21 extracts sound data and image data from the delivery data. The communication unit 21 outputs the sound data to the sound decoder 22. The communication unit 21 outputs the image data to the image decoder 23.

The sound decoder 22 receives the sound data from the communication unit 21. The sound decoder 22 decodes the sound data to generate sound signals. The sound decoder 22 outputs the sound signals to the processing unit 26.

The image decoder 23 receives the image data from the communication unit 21. The image decoder 23 decodes the image data to generate image signals. The image decoder 23 outputs the image signals to the processing unit 26.

The operation unit 24 includes e.g. various operation buttons, an operation key, or a touch panel. The operation unit 24 is provided in a housing of the projector 2. The operation unit 24 receives various instructions from the user. For example, the operation unit 24 individually receives a sound quality instruction to instruct sound quality and an image quality instruction to instruct image quality. The operation unit 24 outputs the instructions to the processing unit 26.

The memory unit 25 is a recording medium readable by the processing unit 26. The memory unit 25 includes e.g. a nonvolatile memory and a volatile memory. The nonvolatile memory is e.g. a ROM (Read Only Memory), an EPROM (Erasable Programmable Read Only Memory), or an EEPROM (Electrically Erasable Programmable Read Only Memory). The volatile memory is e.g. a RAM. The memory unit 25 stores programs to be executed by the processing unit 26 and various kinds of data to be used by the processing unit 26.

The processing unit 26 includes e.g. one or more processors. As an example, the processing unit 26 includes one or more CPUs (Central Processing Units). Part or all of the functions of the processing unit 26 may be realized by a circuit such as a DSP (Digital Signal Processor), an ASIC (Application Specific Integrated Circuit), a PLD (Programmable Logic Device), or an FPGA (Field Programmable Gate Array). The processing unit 26 parallelly or sequentially execute various kinds of processing.

The processing unit 26 receives the sound signals from the sound decoder 22. The processing unit 26 receives the image signals from the image decoder 23. The processing unit 26 individually receives the sound quality instruction and the image quality instruction from the operation unit 24. The processing unit 26 adjusts at least the sound quality of the sound represented by the sound signals according to the sound quality instruction. The processing unit 26 adjusts at least the image quality of the images represented by the image signals according to the image quality instruction.

The processing unit 26 reads the programs from the memory unit 25. The processing unit 26 executes the programs, and thereby, realizes a sound processing unit 261, an image processing unit 262, and an operation control unit 263.

The sound processing unit 261 receives the sound signals from the sound decoder 22. The sound processing unit 261 processes the sound signals. For example, the sound processing unit 261 processes the sound signals, and thereby, adjusts the sound quality of the sound represented by the sound signals.

Hereinafter, the sound signal before processing by the sound processing unit 261 is referred to as “first sound signal”. The sound signal after processing by the sound processing unit 261 is referred to as “second sound signal”. When the sound processing unit 261 performs processing of changing the sound quality, the sound quality of the sound represented by the second sound signal is different from the sound quality of the sound represented by the first sound signal. When the sound processing unit 261 performs processing of maintaining the sound quality, the sound quality of the sound represented by the second sound signal is the same as the sound quality of the sound represented by the first sound signal. The processing of maintaining the sound quality is e.g. processing of outputting the first sound signal as the second sound signal by the sound processing unit 261.

The sound processing unit 261 outputs the second sound signal to the sound signal output unit 27. The sound processing unit 261 may include one or more circuits such as sound processors.

The image processing unit 262 receives the image signals from the image decoder 23. The image processing unit 262 processes the image signals. For example, the image processing unit 262 processes the image signals, and thereby, adjusts the image quality of the images represented by the image signals.

Hereinafter, the image signal before processing by the image processing unit 262 is referred to as “first image signal”. The image signal after processing by the image processing unit 262 is referred to as “second image signal”. When the image processing unit 262 performs processing of changing the image quality, the image quality of the image represented by the second image signal is different from the image quality of the image represented by the first image signal. When the image processing unit 262 performs processing of maintaining the image quality, the image quality of the image represented by the second image signal is the same as the image quality of the image represented by the first image signal. The processing of maintaining the image quality is e.g. processing of outputting the first image signal as the second image signal by the image processing unit 262.

The image processing unit 262 outputs the second image signal to the projection unit 28. The image processing unit 262 may include one or more circuits such as image processors.

The operation control unit 263 controls the operation of the projector 2. The operation control unit 263 controls e.g. the sound processing unit 262 and the image processing unit 262. The operation control unit 263 receives a sound quality instruction from the operation unit 24. The operation control unit 263 controls at least the sound processing unit 261 based on the sound quality instruction. The operation control unit 263 receives an image quality instruction from the operation unit 24. The operation control unit 263 controls at least the image processing unit 262 based on the image quality instruction. The operation control unit 263 may include one or more circuits such as processors.

The sound signal output unit 27 is e.g. an output terminal for sound signal. The sound signal output unit 27 is not limited to an output terminal, but maybe e.g. a communication device that, transmits the sound signal via wired or wireless connection. The sound signal output unit 27 receives the second sound signal from the sound processing unit 261. The sound signal output unit 27 outputs the second sound signal to the sound output device 3.

The projection unit 28 receives the second image signal from the image processing unit 262. The projection unit 28 projects an image represented by the second image signal on the projection surface 4 and displays the image on the projection surface 4. The projection unit 28 is an example of a display unit.

### A3: Example of Projection Unit 28

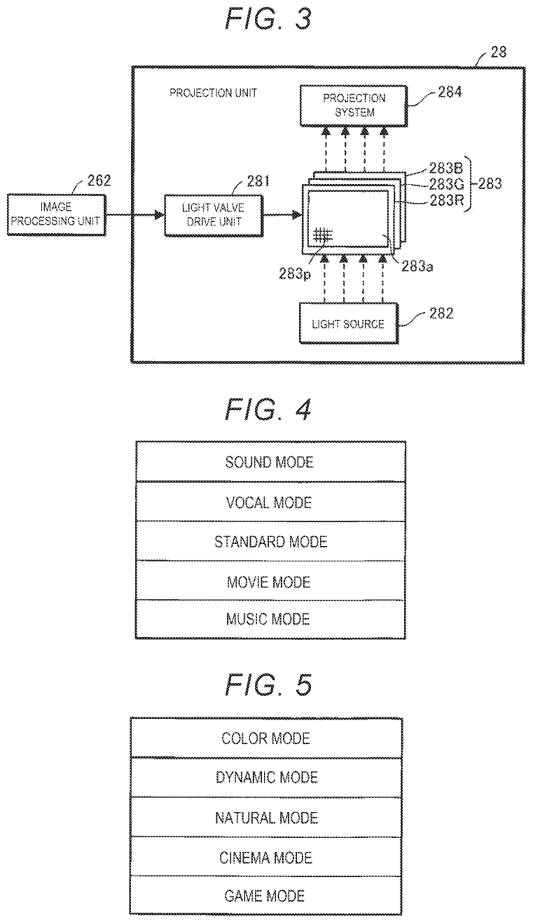

FIG. 3 shows an example of the projection unit 28. The projection unit 28 includes a light valve drive part 281, a light source 282, a red liquid crystal light valve 283R, a green liquid crystal light valve 283G, a blue liquid crystal light valve 283B, and a projection system 284. Hereinafter, when it is unnecessary to distinguish the red liquid crystal light valve 283R, the green liquid crystal light valve 263G, and the blue liquid crystal light valve 2833 from one another, these are referred to as “liquid crystal light valves 283”.

The light valve drive part 281 includes e.g. a circuit such as a driver. The light valve drive part 281 receives the second image signal from the image processing unit 262. The light valve drive part 281 generates a drive voltage based on the second image signal. The light valve drive part 281 drives the liquid crystal light valves 283 by applying the drive voltage to the liquid crystal light valves 283.

The light source 282 is e.g. an LED (light emitting diode). The light source 282 is not limited to the LED, but may be a xenon lamp, an extra-high pressure mercury lamp, or a laser beam source. The light source 282 outputs a light. The light output from the light source 282 enters an optical integration system (not shown). The optical integration system reduces variations in a luminance distribution in the light output from the light source 282. The light output from the light source 282 passes through the optical integration system, and then, is separated into color light components of red, green, blue as three primary colors of light by a color separation system (not shown). The red color light component enters the red liquid crystal light valve 233R. The green color light component enters the green liquid crystal light valve 283G. The blue color light component enters the blue liquid crystal light valve 283B.

The liquid crystal light valve 283 includes a liquid crystal panel with liquid crystal between a pair of transparent substrates. The liquid crystal light valve 283 has a rectangular pixel area 283a containing a plurality of pixels 283p located in a matrix form. In the liquid crystal light valve 283, a drive voltage is applied to the liquid crystal with respect to each pixel 283p. When the light valve drive part 281 applies the drive voltage to each pixel 283p, each pixel 283p is set to light transmittance based on the drive voltage. The light output from the light source 282 is modulated through the pixel area 283a. Accordingly, an image based on the second image signal is formed with respect to each color light. The liquid crystal light valve 283 is an example of a light modulation device.

The images of the respective colors are combined by a light combining system (not shown) with respect to each pixel 283p. Therefore, a color image is generated. The color image is projected via the projection system 284.

### A4: Sound Quality and Image Quality

The projector 2 has a sound mode for setting sound quality and a color mode for setting image quality.

FIG. 4 shows an example of the sound mode. The sound mode includes a vocal mode, a standard mode, a movie mode, and a music mode.

The vocal mode is a mode in which vocal sound quality for emphasizing human voice is set. The standard mode is a mode in which sound quality of sound represented by the first sound signal is maintained. Hereinafter, the sound quality of the sound represented by the first sound signal is referred to as “standard sound quality”. The movie mode is a mode in which movie sound quality for emphasizing human voice and providing a stereoscopic effect suitable for surround reproduction is set. The music mode is a mode in which music sound quality for emphasizing instrumental sound and human voice is set.

The sound mode may contain two or three of the vocal mode, the standard mode, the movie mode, and the music mode. The sound mode may have another mode different from any one of the vocal mode, the standard mode, the movie mode, or the music mode.

FIG. 5 shows an example of the color mode. The color mode includes a dynamic mode, a natural mode, a cinema mode, and a game mode.

The dynamic mode is a mode in which dynamic image quality for respectively emphasizing brightness, contrast, and sharpness is set. The natural mode is a mode in which image quality of an image represented by the first image signal is maintained. Hereinafter, the image quality of the image represented by the first image signal is referred to as “natural image quality”. The cinema mode is a mode in which cinema image quality for respectively emphasizing contrast and sharpness without brightness correction is set. The game mode is a mode in which game image quality for respectively emphasizing brightness and sharpness without contrast correction is set.

The color mode may contain two or three of the dynamic mode, the natural mode, the cinema mode, and the game mode. The color mode may have another mode different from any one of the dynamic mode, the natural mode, the cinema mode, and the game mode.

### A5: Sound Quality Settings and Image Quality Settings

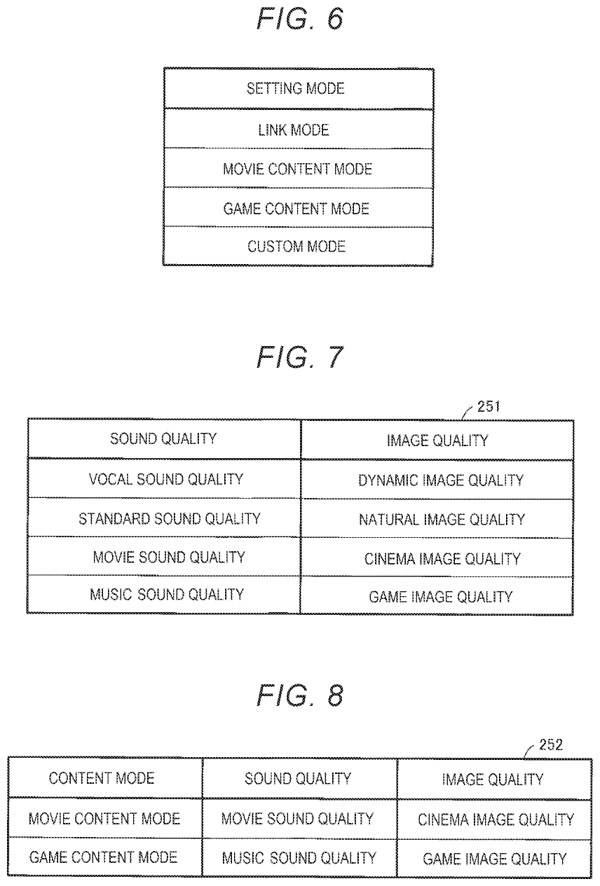

The projector 2 has a setting mode for making sound quality settings and image quality settings. FIG. 6 shows an example of the setting mode. The setting mode includes a link mode, a movie content mode, a game content mode, and a custom mode.

The link mode is a mode in which both sound quality of sound represented by the second sound signal and image quality of an image represented by the second image signal are set according to a sound quality instruction. The link mode is also a mode in which both image quality of an image represented by the second image signal and sound quality of sound represented by the second sound signal are set according to an image quality instruction. The movie content mode is a mode in which the sound quality of the sound represented by the second image signal is set to movie sound quality and the image quality of the image represented by the second image signal is set to cinema image quality. The game content mode is a mode in which the sound quality of the sound represented by the second image signal is set to music sound quality and the image quality of the image represented by the second image signal is set to game image quality. The custom mode is a mode in which the sound quality of the sound represented by the second image signal and the image quality of the image represented by the second image signal are individually set.

FIG. 7 shows an example of a first table 251 used in the link mode. The first table 251 is stored in e.g. the memory unit 25. The first table 251 stores information representing correspondence relationships between sound quality and image quality. For example, the first table 251 stores information representing that the vocal sound quality and the dynamic image quality correspond to each other. The vocal sound quality is an example of first sound quality. The dynamic image quality is an example of first image quality.

The first table 251 stores information representing that the standard sound quality and the natural image quality correspond to each other. The first table 251 stores information representing that the movie sound quality and the cinema image quality correspond to each other. The first table 251 stores information representing that the music sound quality and the game image quality correspond to each other. The standard sound quality, the movie sound quality, and the music sound quality are respectively other examples of the first sound quality. When the standard sound quality is the example of the first sound quality, the natural image quality is an example of the first image quality. When the movie sound quality is the example of the first sound quality, the cinema image quality is an example of the first image quality. When the music sound quality is the example of the first sound quality, the game image quality is an example of the first image quality.

FIG. 8 shows an example of a second table 252 used in the respective movie content mode and game content mode. The second table 252 is stored in e.g. the memory unit 25. The second table 252 stores information representing that the movie content mode, the movie sound quality, and the cinema image quality correspond to one another. The second table 252 stores information representing that the game content mode, the music sound quality, and the game image quality correspond to one another.

### A6. Example of Operation in Setting Mode

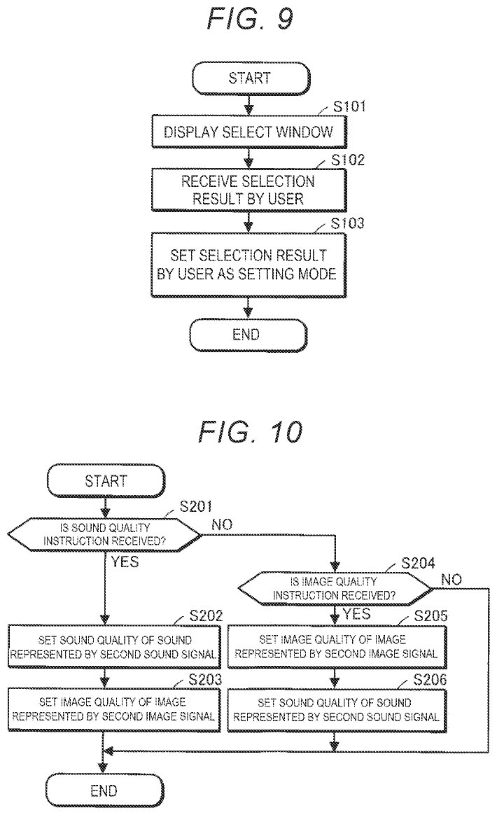

FIG. 9 is a flowchart for explanation of an example of an operation in the setting mode. When the user inputs a setting mode instruction to instruct the setting mode to the operation unit 24, the operation unit 24 outputs the setting mode instruction to the operation control unit 263. When receiving the setting mode instruction, at step S101, the operation control unit 263 controls the projection unit 28 to project a select window for selection of one of the link mode, the movie content mode, the game content mode, and the custom mode on the projection surface 4. For example, the operation control unit 263 provides a select window signal representing the select window to the projection unit 28 via the image processing unit 262, and thereby, controls the projection unit 28 to project the select window on the projection surface 4.

Subsequently, the user selects one of the link mode, the movie content mode, the game content mode, and the custom mode from the select window using the operation unit 24. For example, the user selects one of the link mode, the movie content mode, the game content mode, and the custom mode by operating a cursor displayed in the select window using the operation unit 24. The operation unit 24 outputs a selection result by the user to the operation control unit 263. The operation control unit 263 receives the selection result by the user at step S102, and then, sets the selection result by the user e.g. the link mode as the setting mode at step S103.

### A7: Example of Operation in Link mode

FIG. 10 is a flowchart for explanation of an example of an operation in the link mode. In the link mode, when the user inputs a sound quality instruction to instruct one of the vocal mode, the standard mode, the movie mode, and the music mode to the operation unit 24, the operation unit 24 outputs the sound quality instruction received from the user to the operation control unit 263.

Here, the sound quality instruction to instruct the vocal mode includes an instruction to set the sound quality of the sound represented by the second sound signal to the vocal sound quality. The sound quality instruction to instruct the standard mode includes an instruction to set the sound quality of the sound represented by the second sound signal to the standard sound quality. The sound quality instruction to instruct the movie mode includes an instruction to set the sound quality of the sound represented by the second sound signal to the movie sound quality. The sound quality instruction to instruct the music mode includes an instruction to set the sound quality of the sound represented by the second sound signal to the music sound quality.

When receiving the sound quality instruction at step S201, the operation control unit 263 sets the sound quality of the sound represented by the second sound signal at step S202. Specifically, the operation control unit 263 sets the sound quality of the sound represented by the second sound signal to the sound quality instructed by the sound quality instruction using the sound processing unit 261.

At step S202, for example, when receiving the sound quality instruction to set the sound quality of the sound represented by the second sound signal to the vocal sound quality, the operation control unit 263 outputs a vocal setting instruction to instruct setting of the vocal sound quality to the sound processing unit 261. When receiving the vocal setting instruction, the sound processing unit 261 generates the second sound signal representing the sound represented by the first sound signal with the vocal sound quality by processing the first sound signal according to the vocal setting instruction. The sound processing unit 261 outputs the second sound signal to the sound signal output unit 27. The sound signal output unit 27 outputs the second sound signal to the sound output device 3. Accordingly, the sound output device 3 outputs sound with the vocal sound quality.

Subsequently, at step S203, the operation control unit 263 sets the image quality of the image represented by the second image signal. Specifically, the operation control unit 263 sets the image quality of the image represented by the second image signal to image quality associated with the sound quality instructed by the sound quality instruction using the image processing unit 262. Here, the operation control unit 263 specifies the image quality associated with the sound quality instructed by the sound quality instruction with reference to the first table 251. Note that the operation control unit 263 may specify the image quality associated with the sound quality instructed by the sound quality instruction according to a program.

At step S203, for example, when receiving the sound quality instruction to set the sound quality of the sound represented by the second sound signal to the vocal sound quality, the operation control unit 263 specifies the dynamic image quality associated with the vocal sound quality with reference to the first table 251. Subsequently, the operation control unit 263 outputs a dynamic setting instruction to instruct setting of the dynamic image quality to the image processing unit 262. When receiving the dynamic setting instruction, the image processing unit 262 generates the second image signal representing the image represented by the first image signal with dynamic image quality by processing the first image signal according to the dynamic setting instruction. The image processing unit 262 outputs the second image signal to the projection unit 28. Therefore, the projection unit 28 displays the image with the dynamic image quality on the projection surface 4.

On the other hand, in the link mode, when the user inputs an image quality instruction to instruct one of the dynamic mode, the natural mode, the cinema mode, and the game mode to the operation unit 24, the operation unit 24 outputs the image quality instruction received from the user to the operation control unit 263.

Here, the image quality instruction to instruct the dynamic mode includes an instruction to set the image quality of the image represented by the second image signal to the dynamic image quality. The image quality instruction to instruct the natural mode includes an instruction to set the image quality of the image represented by the second image signal to the natural image quality. The image quality instruction to instruct the cinema mode includes an instruction to set the image quality of the image represented by the second image signal to the cinema image quality. The image quality instruction to instruct the game mode includes an instruction to set the image quality of the image represented by the second image signal to the game image quality.

When receiving the image quality instruction at step S204, the operation control unit 263 sets the image quality of the image represented by the second image signal at step S205. Specifically, the operation control unit 263 sets the image quality of the image represented by the second image signal to the image quality instructed by the image quality instruction using the image processing unit 262.

At step S205, for example, when receiving the image quality instruction to set the image quality of the image represented by the second image signal to the dynamic image quality, the operation control unit 263 outputs a dynamic setting instruction to the image processing unit 262. When receiving the dynamic setting instruction, the image processing unit 262 generates the second image signal representing the image represented by the first image signal with the dynamic image quality by processing the first image signal according to the dynamic setting instruction. The image processing unit 262 outputs the second image signal to the projection unit 28. Accordingly, the projection unit 28 displays the image with the dynamic image quality on the projection surface 4.

Subsequently, at step S206, the operation control unit 263 sets the sound quality of the sound represented by the second sound signal. Specifically, the operation control unit 263 sets the sound quality of the sound represented by the second sound signal to sound quality associated with the image quality instructed by the image quality instruction using the sound processing unit 261. The operation control unit 263 specifies the sound quality associated with the image quality instructed by the image quality instruction with reference to the first table 251.

At step S206, for example, when receiving the image quality instruction to set the image quality of the image represented by the second image signal to the dynamic image quality, the operation control unit 263 specifies the vocal sound quality associated with the dynamic sound quality with reference to the first table 251. Subsequently, the operation control unit 263 outputs a vocal setting instruction to instruct setting of the vocal sound quality to the sound processing unit 261. When receiving the vocal setting instruction, the sound processing unit 261 generates the second sound signal representing the sound represented by the first sound signal with vocal sound quality by processing the first sound signal according to the vocal setting instruction. The sound processing unit 261 outputs the second sound signal to the sound signal output unit 27. The sound signal output unit 27 outputs the second sound signal to the sound output device 3. Accordingly, the sound output device 3 outputs sound with the vocal sound quality.

Note that step S203 may be executed before execution of step S202. Further, step S206 may be executed before execution of step S205.

### A8. Example of Operation in Movie Content Mode

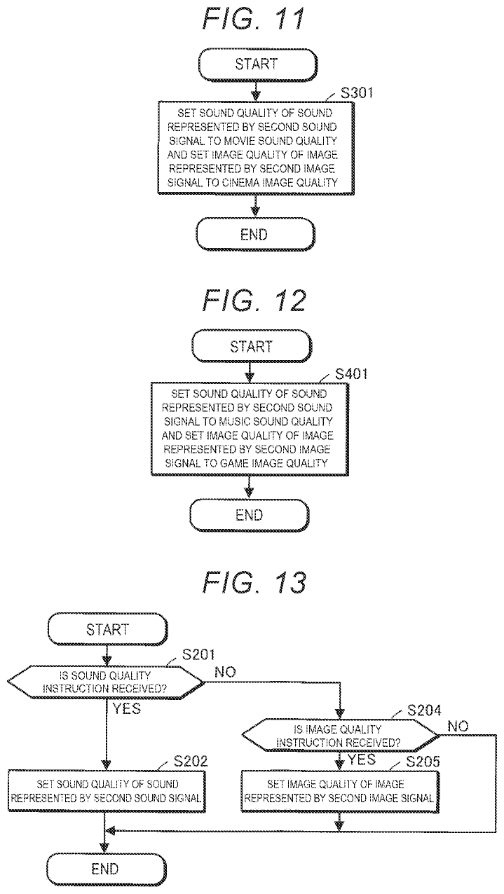

FIG. 11 is a flowchart for explanation of an example of an operation in the movie content mode. When the movie content mode is set, the operation control unit 263 sets the sound quality of the sound represented by the second sound signal to the movie sound quality and sets the image quality of the image represented by the second image signal to the cinema image quality at step S301.

At step S301, the operation control unit 263 first recognizes that the movie sound quality and the cinema image quality are associated with the movie content node with reference to the second table 252.

Subsequently, the operation control unit 263 outputs a movie setting instruction to instruct setting of the movie sound quality to the sound processing unit 261. Further, the operation control unit 263 outputs a cinema setting instruction to instruct setting of the cinema image quality to the image processing unit 262.

When receiving the movie setting instruction, the sound processing unit 261 generates the second sound signal representing the sound represented by the first sound signal with the movie sound quality by processing the first sound signal according to the movie setting instruction. The processing unit 261 outputs the second sound signal to the sound signal output unit 27. The sound signal output unit 27 outputs the second sound signal to the sound output device 3.

When receiving the cinema setting instruction, the image processing unit 262 generates the second image signal representing the image represented by the first image signal with cinema image quality by processing the first image signal according to the cinema setting instruction. The image processing unit 262 outputs the second image signal to the projection unit 28.

### A9: Example of Operation in Game Content Mode

FIG. 12 is a flowchart for explanation of an example of an operation in the game content mode. When the game content mode is set, the operation control unit 263 sets the sound quality of the sound represented by the second sound signal to the music sound quality and sets the image quality of the image represented by the second image signal to the game image quality at step S401.

At step S401, the operation control unit 263 first recognizes that the music sound quality and the game image quality are associated with the game content mode with reference to the second table 252.

Subsequently, the operation control unit 263 outputs a music setting instruction to instruct setting of the music sound quality to the sound processing unit 261. Further, the operation control unit 263 outputs a game setting instruction to instruct setting of the game image quality to the image processing unit 262.

When receiving the music setting instruction, the sound processing unit 261 generates the second sound signal representing the sound represented by the first sound signal with the music sound quality by processing the first sound signal according to the music setting instruction. The processing unit 261 outputs the second sound signal to the sound signal output unit 27. The sound signal output unit 27 outputs the second sound signal to the sound output device 3.

When receiving the game setting instruction, the image processing unit 262 generates the second image signal representing the image represented by the first image signal with game image quality by processing the first image signal according to the game setting instruction. The image processing unit 262 outputs the second image signal to the projection unit 28.

### A10: Example of Operation in Custom Mode

FIG. 13 is a flowchart for explanation of an example of an operation in the custom mode. In FIG. 13, the same processing as the processing shown in FIG. 10 has the same sign. As shown in FIG. 13, in the custom mode, steps S203 and S206 shown in FIG. 10 are omitted.

### A11: Overview of First Embodiment

The operation method for the projector 2 and the projector 2 according to the above described embodiment include the following configurations.

The projection unit 28 displays an image on the projection surface 4. The sound signal output unit 27 outputs a second sound signal representing sound. When receiving the sound quality instruction to set the sound quality of the sound represented by the second sound signal to the first sound quality, the processing unit 26 sets the sound quality of the sound represented by the second sound signal to the first sound quality and sets the image quality of the image displayed on the projection surface 4 to the first image quality associated with the first sound quality.

According to the configuration, for example, when the user inputs the sound quality instruction to set the sound quality of the sound represented by the second sound signal to the first sound quality to the projector 2, both the sound quality and the image quality are set according to the sound quality instruction. Accordingly, it is not necessary for the user to make both a change in sound quality and a change in image quality at each time. Further, when the projector 2 has high portability, the user may easily change the sound quality and the image quality according to an environment in which the projector 2 is set.

The processing unit 26 specifies the first image quality with reference to information representing that the first sound quality and the first image quality correspond to each other according to the instruction. According to the configuration, the processing unit 26 easily specifies the first image quality.

### B: Modified Examples

Configurations of modified examples of the above exemplified embodiments will be exemplified as below. Two or more of the examples arbitrarily selected from the following exemplification may be appropriately combined to be mutually consistent.

### B1: First Modified Example

In the first embodiment, when receiving the sound quality instruction to set the sound quality of the sound represented by the second sound signal to the first sound quality, the processing unit 26 may output the second sound signal to the sound output device associated with the first sound quality.

In this case, for example, the memory unit 25 stores output destination information representing a correspondence relationship between the first sound quality and an output destination of the second sound signal. An example of the correspondence relationship between the first sound quality and the output destination of the second sound signal includes a correspondence relationship between the movie sound quality and a surround speaker. The correspondence relationship between the first sound quality and the output destination of the second sound signal is not limited to the correspondence relationship between the movie sound quality and the surround speaker, but may be appropriately changed.

The operation control unit 263 specifies the output destination corresponding to the first sound quality as the sound output device to which the second sound signal should be output with reference to the output destination information. Then, the operation control unit 263 outputs the second sound signal to the sound output device to which the second sound signal should be output.

According to the example, the output destination of the second sound signal may be automatically determined based on the sound quality instruction.

### B2: Second Modified Example

In the first embodiment, the operation control unit 263 may determine whether or not the output destination of the second sound signal is a predetermined sound output device e.g. a headphone. The predetermined sound output device is not limited to the headphone, but may be appropriately changed.

As an example, the operation control unit 263 first acquires identification information representing a type of the device as the output destination from the output destination of the second sound signal. Subsequently, the operation control unit 263 determines whether or not the output destination of the second sound signal is a predetermined sound output device based on the identification information.

When determining that the output destination of the second sound signal is a predetermined sound output device, the operation control unit 263 may set the sound quality of the sound represented by the second sound signal to sound quality associated with the predetermined sound output device. The sound quality associated with the predetermined sound output device is an example of second sound quality. For example, the memory unit 25 stores sound output device information representing a correspondence relationship between the predetermined sound output device and the sound quality. An example of the correspondence relationship between the predetermined sound output device and the sound quality includes a correspondence relationship between the headphone and the music sound quality. The correspondence relationship between the predetermined sound output device and the sound quality is not limited to the correspondence relationship between the headphone and the music sound quality, but may be appropriately changed.

The operation control unit 263 specifies the sound quality associated with the predetermined sound output device with reference to the sound output device information. The operation control unit 263 controls the sound processing unit 261 to generate the second sound signal representing the sound represented by the first sound signal with sound quality associated with the predetermined sound output device.

According to the example, the sound quality of the sound represented by the second sound signal output to the predetermined sound output device may be automatically set. Note that, afterwards, when the sound quality instruction to set the sound quality of the sound represented by the second sound signal to the first sound quality is input, the sound quality of the sound represented by the second sound signal is changed to the first sound quality.

### B3: Third Modified Example

In the first embodiment, the first modified example, and the second modified example, when receiving the sound quality instruction to set the sound quality of the sound represented by the sound signal to the first sound quality, the operation control unit 263 may control the communication unit 21 to receive image data from an image data delivery apparatus associated with the first sound quality and control the projection unit 28 to display an image based on the image data on the projection surface 4.

For example, there are the distribution server 1 and a DVD player as candidates of the image data delivery apparatus, and the distribution server 1 is associated with the standard sound quality and the DVD player is associated with the movie sound quality.

When the sound quality instruction instructs the standard sound quality, the operation control unit 263 determines the distribution server 1 as the image data delivery apparatus and controls the communication unit 21 to receive the image data from the distribution server 1. In this case, the communication unit 21 also receives sound data from the distribution server 1.

When the sound quality instruction instructs the movie sound quality, the operation control unit 263 determines the DVD player as the image data delivery apparatus and controls the communication unit 21 to receive the image data from the DVD player. In this case, the communication unit 21 also receives sound data from the DVD player.

According to the example, the image data delivery apparatus, i.e., a supply source of image data may be automatically determined.

### B4: Fourth Modified Example

In the first embodiment and the first to third modified examples, when the delivery data received by the communication unit 21 further represents a type of contents shown by the delivery data, the operation control unit 263 may set the movie content mode or the game content mode based on the delivery data. For example, when the delivery data shows movie contents, the operation control unit 263 sets the movie content mode. When the delivery data shows game contents, the operation control unit 263 sets the game content mode.

According to the example, at least one of the movie content mode or the game content mode may be automatically set.

### B5: Fifth Modified Example

In the first embodiment and the first to fourth modified examples, the liquid crystal light valve 283 is used as an example of the light modulation device in the projector 2, however, the light modulation device is not limited to the liquid crystal light valve 283, but may be appropriately changed. For example, the light modulation device may have a configuration using three reflective liquid crystal panels. Or, the light modulation device may have a configuration using a single liquid crystal panel, three digital mirror devices (DMDs), or a single digital mirror device. When only one liquid crystal panel or DMD is used as the light modulation device, members corresponding to the color separation system and the light combining system are unnecessary. Or, other configurations that can modulate the light emitted by the light source 282 than the liquid crystal panel or DMD may be employed as the light modulation device.

### B6: Sixth Modified Example

In the first embodiment and the first to fifth modified examples, when an FPD is used as the display apparatus, the FPD may be an FPD used for an electronic blackboard or an electronic conferencing system.

What is claimed is:

1. An operation method for a display apparatus comprising:
displaying an image on a display surface;
outputting a sound signal representing sound; and
when receiving as instruction to set sound quality of sound represented by the sound signal to first sound quality, setting the sound quality to the first sound quality and setting image quality of the image to first image quality associated with the first sound quality.

2. The operation method according to claim 1, further comprising specifying the first image quality with reference to information representing that the first sound quality and the first image quality correspond to each other according to the instruction.

3. The operation method according to claim 1, further comprising outputting the sound signal to a sound output device associated with the first sound quality when receiving the instruction.

4. The operation method according to claim 1, further comprising:
determining whether or not an output destination of the sound sig is a predetermined sound output device; and
when determining that the output destination of the sound signal is the predetermined sound output device, setting the sound quality to second sound quality associates with the predetermined sound output device.

5. The operation method according to claim 1, further comprising:
receiving image data from as image data delivery apparatus associated with the first sound quality when receiving the instruction; and
displaying the image on the display surface based on the image data.

6. A display apparatus comprising:
a unit that displays an image on a ay surface;
a sound signal output unit that outputs a sound signal representing sound; and
a processing unit, when receiving an instruction to set sound quality of sound represented by the sound signal to first sound quality, that sets the sound quality to the first sound quality and sets image quality of the image to first image quality associated with the first sound quality.
